(19) United States
(12) Patent Application Publication
(10) Pub. No.: US 2007/0155300 A1
(43) Pub. Date: Jul. 5, 2007

(54) Safety device for controlling ventilation of a vehicle compartment

(76) Inventor: Chih-Ching Hsieh, Feng Yuan City (TW)

Correspondence Address: TROXELL LAW OFFICE PLLC;SUITE 1404, 5205 LEESBURG PIKE, FALLS CHURCH, VA, 22041, US

(21) Appl. No.: 11/324,382

(22) Filed: Jan. 4, 2006

(51) Int. Cl. B60H 3/00; B60H 1/00; F25D 17/04

(52) U.S. Cl. 454/75; 62/186; 165/42

(57) ABSTRACT

A safety device for controlling ventilation of a vehicle compartment. The safety device is mounted in a vehicle with electric windows, including: a power supply connected with a motor for driving the electric window; a controlling circuit connected with the power supply; and a thermal sensor disposed in the compartment of the vehicle and connected with the controlling circuit. The thermal sensor serves to sense the temperature in the compartment and transmit signals to the controlling circuit. In the case that the temperature in the compartment reaches a certain value, the controlling circuit powers on the power supply to activate the motor for opening the window. Therefore, the compartment is ventilated and the temperature of the compartment can be lowered.

### BACKGROUND OF THE INVENTION

The present invention is related to a safety device of a vehicle, and more particularly to a safety device for ventilating the compartment of a vehicle so as to lower the temperature of the compartment and avoid danger.

Generally, after parking a car outdoors, a driver will close all the windows for burglarproof purpose. After a period of time, the temperature inside the sealed compartment of the car will be very high. This makes the compartment of the car just like a baker. In the case that a person is stuck in such compartment, the person will soon dehydrate and cramp or even die in short time. It was often heard that children were incautiously left in sealed car compartments and died accidentally.

Also, the high temperature inside the car compartment will make the plastic parts of the car release toxic gas. After a person enters such car compartment, the person will breathe the toxic gas which is harmful to human body.

### SUMMARY OF THE INVENTION

It is therefore a primary object of the present invention to provide a safety device for controlling ventilation of a vehicle compartment. In the case that the temperature in a sealed compartment reaches a certain value, the window of the vehicle will automatically open to lower the temperature of the compartment. Also, a person stuck in the compartment can cry for help through the window.

It is a further object of the present invention to provide the above safety device for controlling ventilation of the vehicle compartment. Besides the natural convection, the safety device further includes a fan for forcedly ventilating the compartment of the vehicle.

The present invention can be best understood through the following description and accompanying drawings.

### BRIEF DESCRIPTION OF THE DRAWINGS

FIG. 1 is a block diagram of the safety device of the present invention;

FIG. 2 shows that the window of the car is opened and the air is conducted into the compartment of the car;

FIG. 3 shows that the window of the car is opened and the air is exhausted from the compartment of the car;

FIG. 4 is a block diagram of a preferred embodiment of the present invention, in which the activation temperature and closing temperature are preset in the thermal sensing chip; and

FIG. 5 is a block diagram of still another embodiment of the present invention, in which the activation temperature and closing temperature are preset in the controlling circuit.

### DETAILED DESCRIPTION OF THE PREFERRED EMBODIMENTS

The safety device of the present invention is applicable to a vehicle with electric windows, such as a car or a bus. When the temperature of a compartment of the vehicle reaches a certain value, the windows of the vehicle are automatically opened for convection between the air inside the compartment and the air outside the vehicle. Therefore, the temperature of the compartment can be lowered.

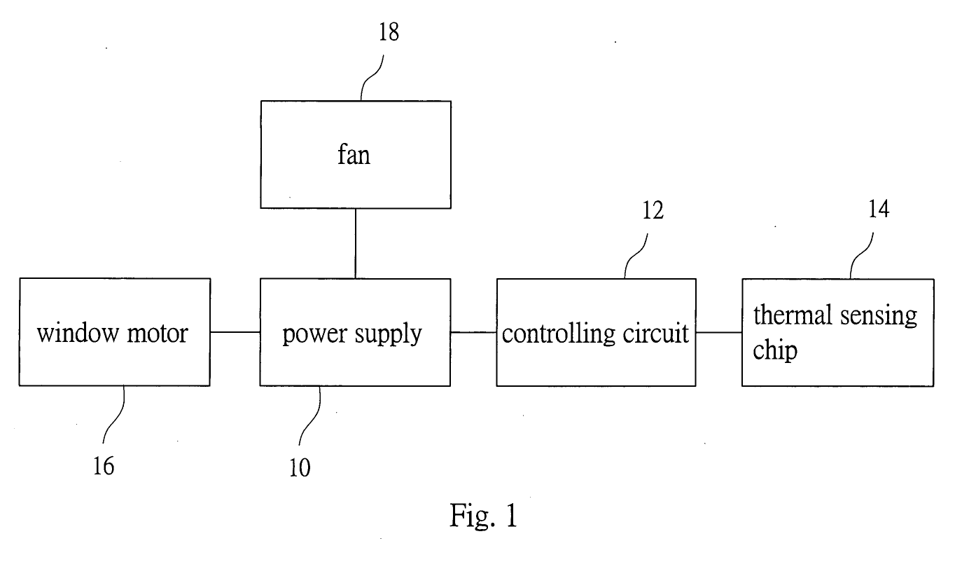

Please refer to FIG. 1. A first embodiment of the safety device of the present invention includes a power supply 10, a controlling circuit 12 connected with the power supply 10 and a thermal sensor 14 which can be a thermal sensing chip 14 connected with the controlling circuit 12 for transmitting signals to the circuit. The power supply 10 is also connected with a window motor 16 of the vehicle and a fan 18.

The thermal sensing chip 14 serves to sense the temperature of the environment and transmit the temperature message to the controlling circuit 12 by way of electronic signals. When the temperature reaches a set value, the controlling circuit activates the window motor 16 to ascend/descend the window.

In this embodiment, the thermal sensing chip 14 is installed inside the compartment. For example, it can be mounted in the instrument panel or under a seat for sensing the temperature inside the compartment. The controlling circuit 12 can receive the temperature message transmitted from the thermal sensing chip 14 to decide whether the window motor 16 should be activated.

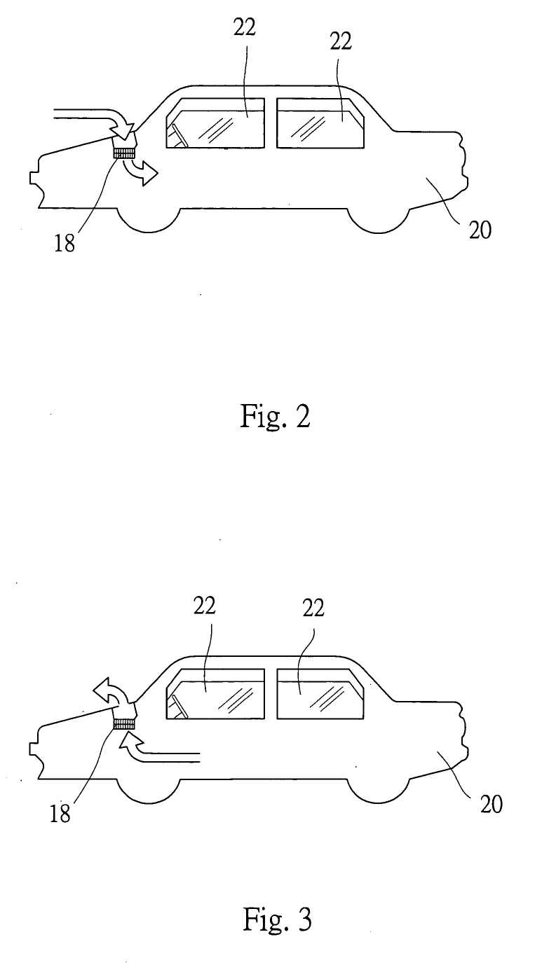

When the temperature of a sealed compartment reaches a certain value, for example, 35° C., the controlling circuit will receive the temperature message and power on the power supply 10 to activate the window motor 16. At this time, the window glass 22 of the vehicle 20 will descend as shown in FIG. 2. Therefore, the convection between the air inside the compartment and the external air will take place to effectively lower the temperature of the compartment.

In practice, the window motor can drive and fully open the window. Alternatively, as shown in FIG. 2, the window can be only partially opened to leave a gap such as 5 cm. Under such circumstance, an unauthorized person cannot extend his hand into the compartment to open the door. A limit switch can be mounted in the ascending/descending path of the window so as to control the gap.

The safety device of the present invention can be preset with an activation temperature and a closing temperature. The activation temperature is preset for opening the window, such as the aforesaid 35° C. The closing temperature can be a preset value of temperature for closing the window.

After the compartment is ventilated and the temperature of the compartment is lowered to the closing temperature such as 26° C., the thermal sensing chip 14 will transmit the temperature message to the controlling circuit 12. At this time, the controlling circuit 12 powers on the power supply 10 to activate the window motor 16 for ascending the window glass and closing the window.

After the window is opened, by means of the convection between internal air and external air, the temperature of the compartment is lowered. In the case of raining, the temperature in the vehicle will be soon lowered to the closing temperature, and the window will be closed again to prevent the rain from entering the compartment.

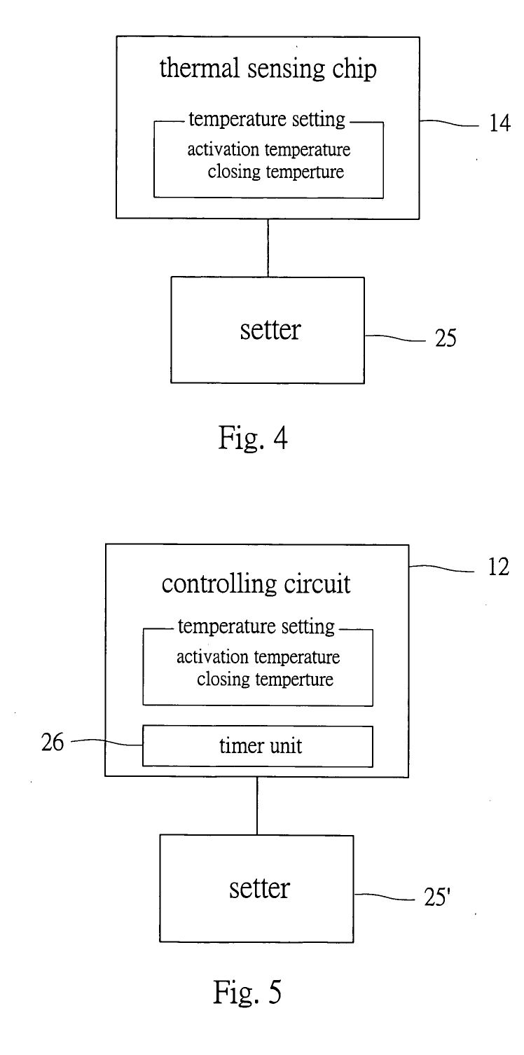

Referring to FIG. 4, the activation temperature and the closing temperature can be inbuilt in the thermal sensing chip 14. When the temperature sensed by the thermal sensing chip 14 reaches the activation temperature or the closing temperature, the thermal sensing chip will transmit signals to the controlling circuit to open or close the window of the vehicle.

Alternatively, as shown in FIG. 5, the activation temperature and the closing temperature can be built in the controlling circuit 12. In this case, the thermal sensing chip 14 continuously transmits the temperature message to the controlling circuit. When the temperature message reaches a set value of the activation temperature or the closing temperature, the controlling circuit will open or close the window of the vehicle.

In both cases, the activation temperature and the closing temperature can be fixed and unadjustable values. Preferably, the activation temperature and the closing temperature are resettable by a user with a setter 25, 25′ as shown in FIGS. 4 and 5.

Referring to FIG. 5, a timer unit 26 can be added to the controlling circuit 12. After the window is opened, the timer unit 26 starts timing. After a period of time, for example, three minutes, in case the temperature in the compartment is not apparently lowered or still not lowered to the closing temperature, the safety device will activate the fan 18 to forcedly ventilate the compartment.

The fan 18 can be an externally connected fan mounted in the vehicle for blowing air in the compartment. Preferably, the vehicle's own fan serves as the fan 18. Referring to FIG. 2, a vehicle has an air-conditioner pipeline communicating with the interior of the compartment. The compartment is ventilated through the air-conditioner pipeline. By means of the fan 18 and the pipeline, the external air can be sucked into the compartment as shown in FIG. 2. Alternatively, as shown in FIG. 3, the fan can be operated in reverse direction to exhaust the hot air from the compartment. Accordingly, the ventilation of the compartment is speeded to more quickly lower the temperature of the compartment.

After the temperature is lowered to the closing temperature, the controlling circuit 12 stops the fan 18 from operating. Preferably, the timing duration of the timer unit 26 is settable by a user.

It should be noted that in practice, when the window is opened, the fan can be simultaneously activated without using the timer unit.

According to the above arrangement, when the temperature in the compartment rises to a high temperature, the window of the vehicle will automatically descend to unseal the compartment and lower the temperature thereof. This protects children from danger in case the children are incautiously left behind in the compartment. Also, the toxic gas produced in the compartment can be exhausted. In addition, after the window is opened, the children can cry for help through the window and get rescued. Accordingly, the safety device of the present invention ensures safety of children left in the vehicle.

The above embodiments are only used to illustrate the present invention, not intended to limit the scope thereof. Many modifications of the above embodiments can be made without departing from the spirit of the present invention.

What is claimed is:

1. A safety device for controlling ventilation of a vehicle compartment, the safety device being mounted in a vehicle with electric windows, the safety device comprising:
a power supply installed in the vehicle and connected with a window motor of the vehicle;
a controlling circuit connected with the power supply; and
a thermal sensor disposed in the compartment of the vehicle and connected with the controlling circuit, the thermal sensor serving to sense the temperature in the compartment and transmit signals to the controlling circuit, whereby in the case that the temperature reaches a certain value, the controlling circuit powers on the power supply to activate the window motor for opening the window.

2. The safety device as claimed in claim 1, wherein a value of an activation temperature is preset in the safety device, whereby when the temperature of the compartment reaches the activation temperature, the controlling circuit activates the motor to open the window.

3. The safety device as claimed in claim 2, wherein the value of the activation temperature is preset in the thermal sensor, whereby when the temperature of the compartment reaches the activation temperature, the thermal sensor transmits a signal to the controlling circuit.

4. The safety device as claimed in claim 2, wherein the value of the activation temperature is preset in the controlling circuit.

5. The safety device as claimed in claim 3, further comprising a setter for setting the value of the activation temperature.

6. The safety device as claimed in claim 4, further comprising a setter for setting the value of the activation temperature.

7. The safety device as claimed in claim 2, wherein a value of a closing temperature is preset in the safety device, whereby when the temperature of the compartment is lowered from the activation temperature to the closing temperature, the controlling circuit activates the motor to close the window.

8. The safety device as claimed in claim 7, wherein the value of the closing temperature is preset in the thermal sensor, whereby when the temperature of the compartment reaches the closing temperature, the thermal sensor transmits a signal to the controlling circuit.

9. The safety device as claimed in claim 7, wherein the value of the closing temperature is preset in the controlling circuit.

10. The safety device as claimed in claim 8, further comprising a setter for setting the value of the closing temperature.

11. The safety device as claimed in claim 9, further comprising a setter for setting the value of the closing temperature.

12. The safety device as claimed in claim 1, further comprising a fan disposed in the vehicle and connected with the power supply for blowing air into the compartment or exhausting the air out of the compartment; the controlling circuit serving to power on the power supply for operating the fan.

13. The safety device as claimed in claim 12, wherein the controlling circuit includes a timer unit, whereby when the window is opened, the timer unit starts timing and after a period of time, the controlling circuit activates the fan.

14. The safety device as claimed in claim 13, wherein the timing duration of the timer unit is resettable.

15. The safety device as claimed in claim 1, wherein the power supply is a battery of the vehicle.

16. The safety device as claimed in claim 12, wherein the fan is a fan of air-conditioner pipeline of the vehicle.
